(19) United States
(12) Patent Application Publication
(10) Pub. No.: US 2019/0160855 A1
(43) Pub. Date: May 30, 2019

(54) ANIMATED WRITING INSTRUMENT SHARPENER

(71) Applicant: ALI BOUDA, Encino, CA (US)

(72) Inventor: ALI BOUDA, Encino, CA (US)

(21) Appl. No.: 16/168,704

(22) Filed: Oct. 23, 2018

Related U.S. Application Data
(60) Provisional application No. 62/575,800, filed on Oct. 23, 2017.

(51) Int. Cl. B43L 23/00

(52) U.S. Cl. CPC B43L 23/008

(57) ABSTRACT

An animated writing instrument sharpener for sharpening a writing instrument. The animated writing instrument sharpener having a housing, a sharpener, an illumination source and a circuit connecting the illumination source to the sharpener. The sharpener is disposed in the housing and is provided to sharpen the writing instrument. The electronic circuit connects the illumination source to the sharpener, such that when the writing instrument is received within the sharpener, the circuit sends an activation signal to activate the illumination source and cause animation to occur. A safety touch sensor is provided such that if a user contacts the entry to the sharpener, a motor driving the cutters of the sharpener is shut off.

### CROSS REFERENCE TO RELATED APPLICATION

This application is a Non-Provisional application which claims the benefit of the filing date of U.S. Provisional Application Ser. No. 62/575,800, entitled “Animated Writing Instrument Sharpener” filed Oct. 23, 2017, the entirety of which is incorporated herein by reference.

### TECHNICAL FIELD

The subject disclosure relates to an office accessory, particularly one that serves as an animated writing instrument sharpener.

### BACKGROUND

Conventionally, pencils were sharpened by shaving an end with a knife or other sharp edge. Shortly after the turn of the 18th century, pencil sharpeners were developed and made this task much easier and provided a more uniform result. Sharpeners are often rudimentary and serve no other purpose then to sharpen a pencil.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 is an exemplary upper front perspective view of an animated writing instrument sharpening device according to the subject disclosure.

FIG. 2 is an upper rear perspective view of the animated writing instrument sharpening device.

FIG. 3 is a top perspective view of the animated writing instrument sharpening device.

FIG. 4 is a lower perspective view of the animated writing instrument sharpening device.

FIG. 5 is a top perspective view of the animated writing instrument sharpening device having its collection housing removed.

FIGS. 6A and 6B illustrate an exemplary animated writing instrument holder embodied as a unicorn.

FIGS. 7A-7C show an exemplary animated writing instrument sharpener embodied as a train car.

FIGS. 8A-8D is a front, top, side and lower view of the animated writing instrument sharpening device as a fire rescue vehicle.

FIGS. 9A-9C is a rear, other side and lower perspective view of the animated writing instrument sharpening device as a fire rescue vehicle.

FIGS. 10A-10D is a front, top, side and lower view of the animated writing instrument sharpening device as a police vehicle.

FIGS. 11A-11C is a rear, other side and lower perspective view of the animated writing instrument sharpening device as a police vehicle.

FIGS. 12A-12C is a front, top, side and lower view of the animated writing instrument sharpening device as an ice cream vehicle.

FIGS. 13A-13C is a rear, other side and lower perspective view of the animated writing instrument sharpening device as an ice cream vehicle.

### DETAILED DESCRIPTION

Particular embodiments of the present subject disclosure will now be described in greater detail with reference to the figures.

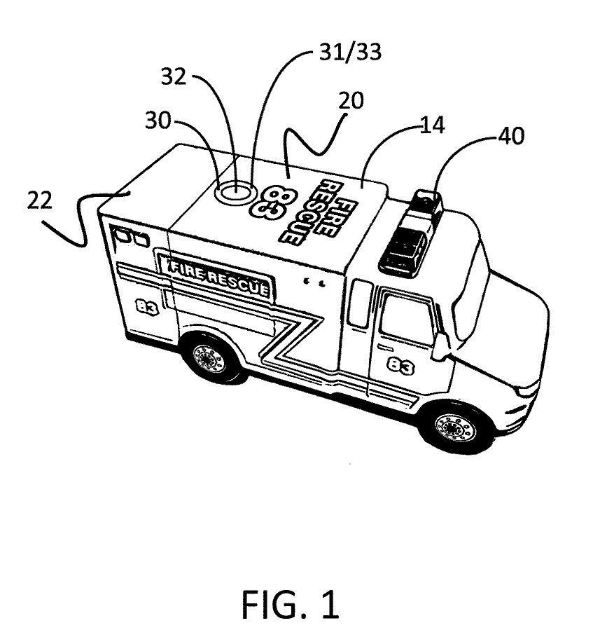

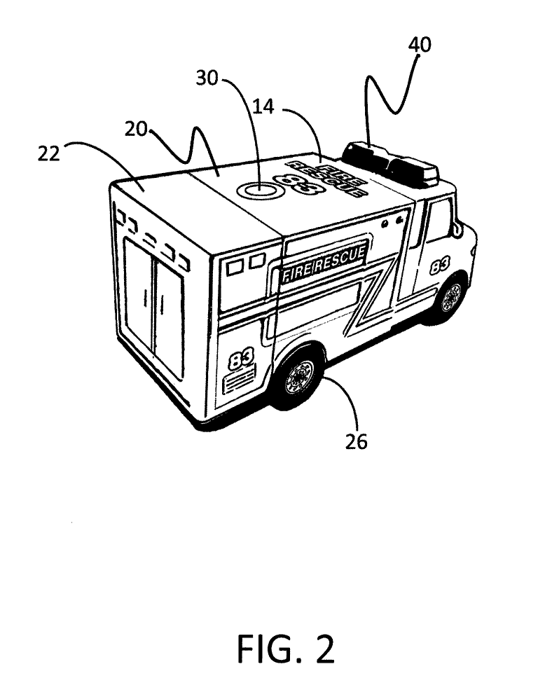

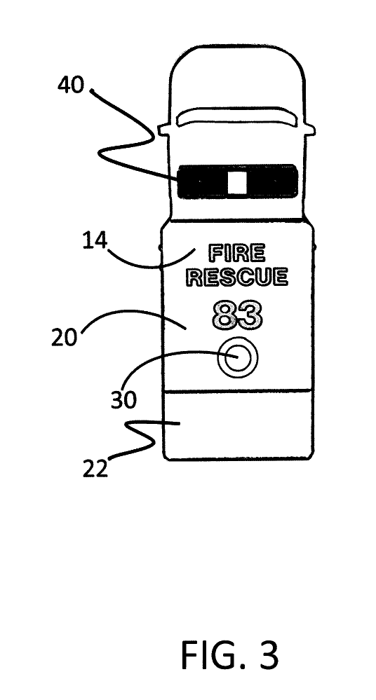

FIGS. 1-4 illustrate an animated writing instrument sharpener 10. The writing instrument sharpener 10 is shown as a vehicle 12. More specifically, the vehicle 12 is an emergency vehicle 14. The vehicle 12 may have entertainment value and/or functional use as a writing instrument sharpener 10. The emergency vehicle 14 includes a housing 20, a sharpener 30 and an illumination source 40.

As described later, the writing instrument sharpener 10 may be constructed in a variety of different shapes, such as a vehicle, an animal and or any other object shape according to this subject disclosure to provide various types of entertainment for a user. The writing instrument 5 to be sharpened can be one of a variety of different marking instruments such as a pencil, a makeup liner or other type of marking instrument.

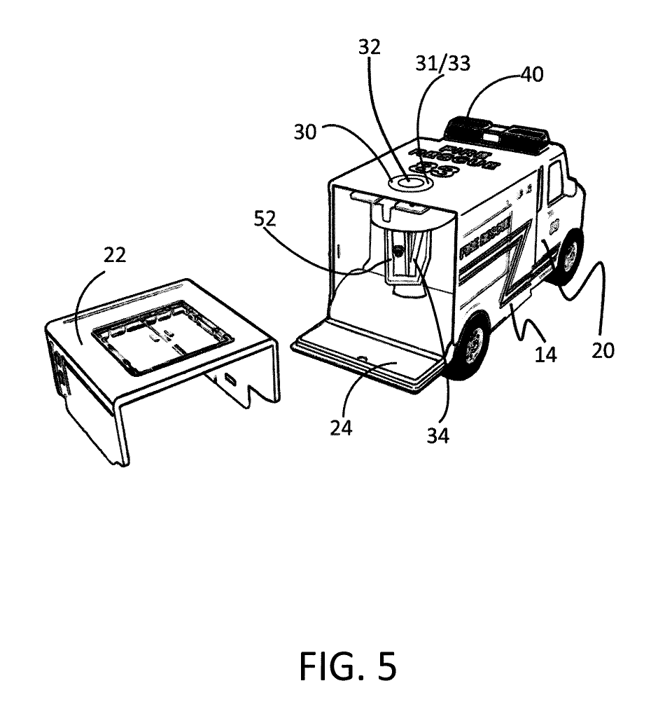

FIG. 5 illustrates the housing 20 of the emergency vehicle 14 can be modularly disassembled to include a collector housing 22 adjacent to the sharpener 30. In use, writing instrument shavings from the sharpener 30 can be collected within the collector 24. To empty the writing instrument shavings from the collector 24, the collector housing 22 may be removed and/or opened and the shavings may be discarded from the collector 24 into an external waste receptacle.

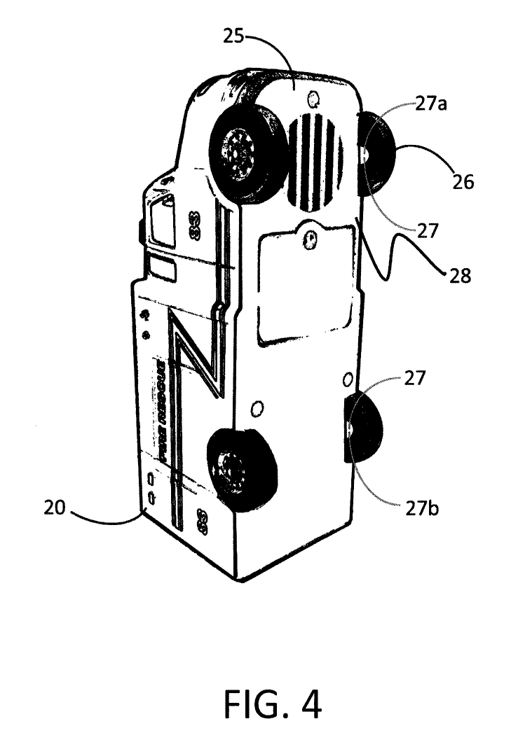

FIG. 4 depicts a bottom view of the housing 20 including a chassis 25 at the lower end of the housing 20. The chassis 25 includes the attachment of wheels 26. The wheels 26 may be attached in a variety of different ways such as with a pair of axles 27, a front 27a and rear 27b axle securing two sets of wheels 26, or by each wheel 26 having independent axles attached to the chassis 25.

The housing 20 contains a battery door 28 into which batteries may be inserted and stored in order to power a circuit 50 connecting the instrument sharpener 10 to provide various operations, such as to the illumination source 40, to power an animation by at least one or more portions of the instrument sharpener 10 as will be described in more detail later.

The wheels 26 of the vehicle 12 may be fixed to prevent movement of the writing instrument sharpener 10. The outer surface of the wheels 26 may be made of a non-slip friction stabilizing material adapted to prevent the rotation of the wheels 26 such that when the writing instrument 5 is pushed into the sharpening aperture 32, the force applied by a user securely holds the writing instrument sharpener 10 in place and does allow the writing instrument sharpener 10 to move.

Alternatively, the wheels 26 of the vehicle 12 may be adapted to roll along a flat surface. The vehicle 12 may be powered to roll in a variety of different ways, such as by an electric motor, a pull-back spring motor, manually or other suitable locomotion mechanism.

If an electric motor 52 is employed, a simple motor may be used in which the motor includes an axle, a nylon end cap and two battery leads such that when the battery leads of the batteries are connected to the motor, the axle will spin driving the vehicle 12 forward (or reverse based on polarity). Likewise, current can be supplied to the illumination source 40 to activate lights therein.

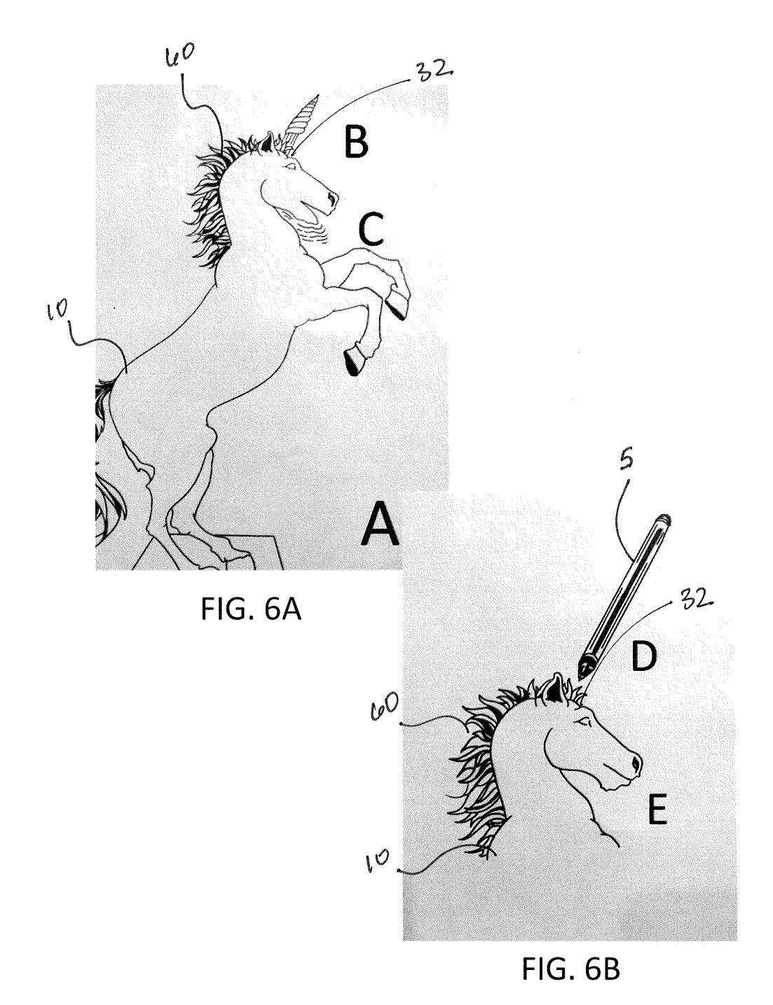

Furthermore, the motor 52 may be structurally linked to cause mechanical animation of a portion of the writing instrument sharpener 10. FIGS. 6A and 6B illustrate one example of an animated portion of the writing instrument sharpener 10. Here, it is to be understood that the animated vehicle 12 can be embodied as any type of animated object, such as a unicorn. In this embodiment, the unicorn 60 may receive the writing instrument 5 in the forehead, for example, approximately where a unicorn 60 would have a horn. The horn can be removed to receive the writing instrument 5. In one aspect, when the writing instrument 5 is placed into the aperture 32, the circuit 50 initiates an activation signal to animate a portion of the unicorn 60. The activation signal, for example, causes the mouth of the unicorn to move. Other instructions may be caused by the activation signal, such as to activate an illumination source and/or to cause an audible sound to emanate therefrom. For example, once the writing instrument 5 is inserted, the unicorn 60 can be activated to cause movement (of say its mouth) and perhaps make an audible sound such as a horse neigh sound that is commonly made by a horse. Movement of the unicorn 60 can be activated upon insertion of the writing instrument 5 or removal thereof. It is to be understood that movement can be made of various portions of the instrument sharpener 10.

Referring back to the instrument sharpener 10 being embodied as a vehicle with wheels, if a pull-back spring motor is used, pulling the vehicle 12 backward winds up an internal coil spring so that when released, the vehicle is propelled forward by the spring. When the spring has unwound and the vehicle is moving, the motor may be disengaged by a clutch or ratchet and the car may then roll freely onward. The pull-back spring motor may be integrated as a generator which collects energy when it is pulled back and exerts the energy in the form of propulsion and establishing a current flow to the illumination source 40 as it unwinds.

Referring back to FIGS. 1-3 and 5, the sharpener 30 is secured into a side of the housing 20. The sharpener 30 has a cone shaped hole 32 that defines the boundary for the sharpened end of the writing instrument 5 pushed therein.

The sharpener 30 may have cylindrical cutters 34 that are rotated by the electric motor 52. The electric motor 52 can be powered by batteries self-contained within the instrument sharpener 10 or by a power source connected to a wall. Using batteries allows the sharpener 10 to be portable. The cylindrical cutters 34 may be planetary sharpeners positioned at an acute angle to each other.

The writing instrument 5 is inserted into the cone-shaped 32 hole, and once the end of the writing instrument 5 is sensed within the hole by a start switch, the motor 52 is activated to rotate the set of helical cylindrical cutters 34 in the sharpener.

The cylindrical cutters 34 have multiple cutting edges that when rotated, quickly sharpen the writing instrument 5. It is understood that the instrument sharpener 10 may be constructed with one or more helical cutter cylinder(s) 34. The instrument sharpener 10 may include a rotatable guide disk that has multiple holes of varied sizes to accommodate writing instruments 5 of many different diameters. The sharpener 30 may also include a spring-driven holder for the writing instrument 5 so that the writing instrument 5 is automatically caused to be inserted into the cylindrical cutters 34 while being sharpened. A regulator may be provided to regulate a desired sharpness, since it may not be desired to make the writing instrument tip needle-sharp. The regulator may cause the instrument sharpener 10 to automatically stop when the instrument tip has obtained a desired sharpness as will be described below. The collector housing 22 of the instrument sharpener 10 collects the writing instrument shavings and will need to be emptied periodically.

An auto-stop switch detector may be provided shut off the current to the electric motor 52 to stop the sharpening of the writing instrument 5 at a predetermined time, such as when the tip is long enough or appropriately sharpened to a desired length. The objective would be to prevent the tip of the writing instrument 5 from becoming too long and break. Therefore, an appropriate auto-stop mechanism may be included to stop the sharpening action of the instrument sharpener 10 against the writing instrument.

Another safety tactile auto-stop sensor can be integrated into the sharpener 30. The tactile safety sensor can be a touch sensitive sensor switch or touch switch 31 that will automatically stop the sharpener motor 52 when the presence of skin contact in sensed on an entry aperture housing 33. The entry aperture housing 33 includes a surface surrounding the entry aperture for the sharpener 30. The entry aperture housing 33 may be constructed of a touch sensitive material such that when skin contact is made, the touch switch 31 is activated and the motor 52 is instructed to shut off, so as to prevent dangerous contact of a user's finger with the cutting mechanism of the sharpener 30.

Various types of tactile touch switches can be integrated into the entry aperture housing. For example, the touch switch 31 can be embodied as a capacitance switch. Since everything has capacitance, the entry aperture housing 33 (FIG. 5) in combination with a portion of a human body, like a user's finger can be used to activate a touch switch 31 in the circuit 50.

As such, the writing instrument sharpener 10 may be designed to turn off the motor 52 driving the cutters 34 of the sharpener 30 by a human touching the entry aperture housing 33 surrounding the opening of the cone shaped hole 32 adapted to receive the writing instrument 5. In the writing instrument sharpener 10, the electrical switch 31 that turns the motor 52 on and off is inside the writing instrument sharpener 10 and attached to the entry aperture housing 33 surrounding the hole 32. This electrical switch 31 is wired to the circuit 50 and the circuit 50 is wired to the inside of the writing instrument sharpener 10.

The entry aperture housing 33 surrounding the hole 32 is adapted to receive the writing instrument 5 has a capacitance to hold an electrical charge or predetermined electron capacity. The human body has a different capacitance from the material of the entry aperture housing 33 surrounding the hole 32. Likewise, the human body and the entry aperture housing 33 surrounding the opening hole 32, together, have a further different capacitance than either one individually. The circuit 50 wired into the writing instrument sharpener 10 is electrically connected to the entry aperture housing 33 surrounding the opening hole 32 and has the ability to detect these changes in capacitance. Thus, when a portion of a human body touches the entry aperture housing 33 surrounding the opening hole 32, the change in capacitance is sensed by the circuit 50 since more electrons are required to fill the portion of the human body and the entry aperture housing 33 surrounding the opening hole 32. The circuit 50 senses the difference and activates an electrical switch 31 to deactivate the motor 52 driving the cutters 34 of the sharpener 30. When the body portion is removed from contacting the entry aperture housing 33, the capacitance of the entry aperture housing 33 goes back to its original capacitance so that it will be ready to detect the next change in capacitance and activate the electrical switch 31 again.

In an alternative embodiment, the capacitance switch may operate with an electrode. The electrode can be integrated into the entry aperture housing 33 and placed behind a surface of the entry aperture housing 33. The surface can be a non-conductive panel such as wood, glass, or plastic. The touch switch works using body capacitance. The surface will continuously charge and discharge its exterior until a change in the capacitance across the surface is detected. When a person touches the surface, the capacitance is increased and triggers the touch switch to turn off the motor in the sharpener 30. The capacitance switch can also be used as a short-range proximity touch sensor switch 31.

Another type of touch sensor may be embodied as a resistance touch switch 31. Like most touch switches, they detect the difference in the capacitance of a plate or electrode when it is being touched by a finger versus the parasitic capacitance of the plate alone. The resistance switch uses two electrodes embedded with the in the entry aperture housing. When the two electrodes are physically in contact with a finger or skin, an amount of electric conductivity is created to activate the touch switch. The resistance between the two electrodes is lowered. Placing a finger across the electrodes activates a turn on or closed state that can activate the touch switch 31 to turn off the motor. Removing the finger from the electrodes restores the operation of the motor of the sharpener 30.

Yet another type of touch sensor may be embodied as a piezo touch switch 31. The piezo touch switch 31 would be based on mechanical bending of piezo ceramic, typically constructed directly behind a surface on the entry aperture housing 33 adjacent to the aperture. The piezo touch switch 31 enables touch interfaces with various kinds of materials. Likewise, the piezo can function as an actuator.

The circuit 50 can be controlled remotely by a wireless connection. That is, a receiver may be integrated into the circuit 50 to send and receive wireless signals or commands to or from a remote wireless controller. The circuit 50 may have an audio speaker embedded therein that cooperates with the illumination source 40 and the rotation of the wheels 26. The circuit 50 may include various sound or light pattern files to emulate a fire truck, a police vehicle, an ice cream truck or other special purpose vehicle.

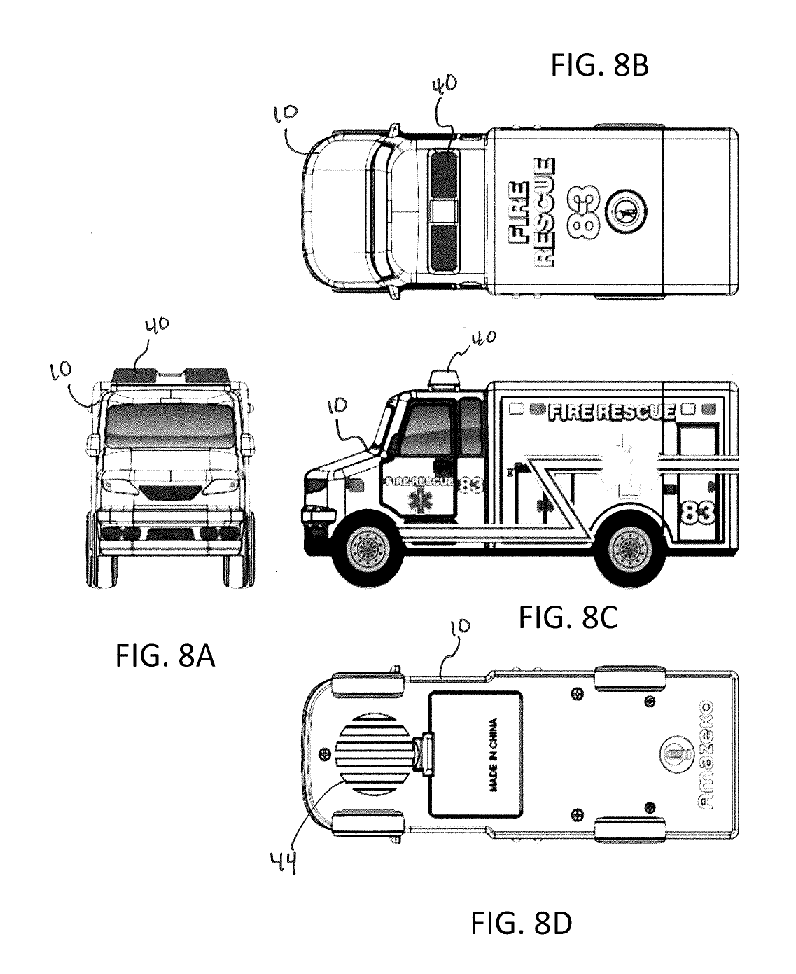

As mentioned previously in FIGS. 6A and 6B, the circuit 50 can also be provided to animate objects. That is, when the writing instrument 5 is inserted into the aperture 32, the electric motor 52 or other means may be provided for moving one or more portions of the object. For example, when the writing instrument 5 is inserted into the aperture 32, the circuit 50 may send an activation signal to the electric motor 52 to drive a solenoid, or the like, to move a portion of the instrument sharpener 10 as the writing instrument 5 is being sharpened. In FIGS. 6A and 6B, the mouth of the unicorn 60 may be driven to open and close. Likewise, the body of the unicorn 60 may be driven to rear upward on its hind legs. Simultaneously, the illumination source 40 and an audio source 44 (as shown in FIG. 8D) may be activated.

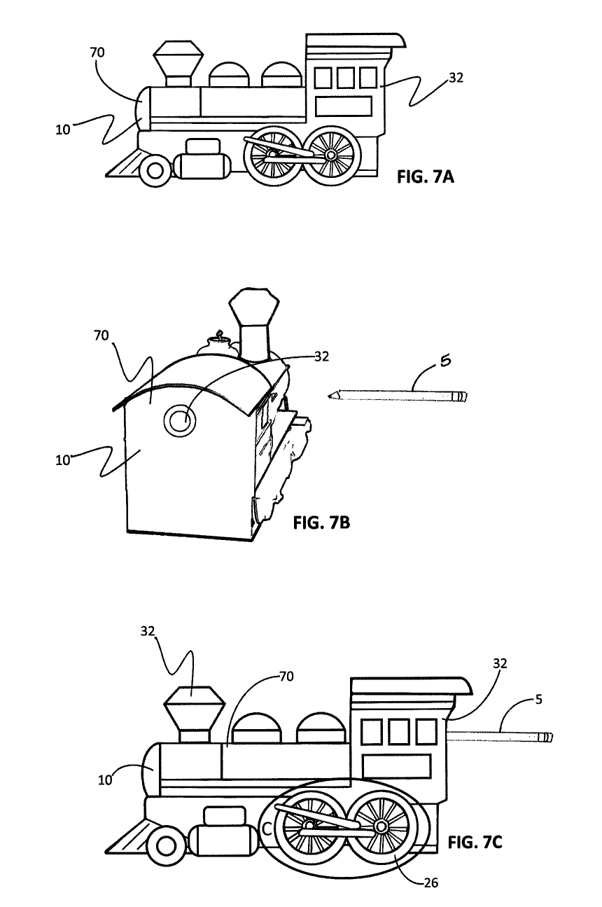

FIGS. 7A-7C illustrate another example of the instrument sharpener 10 embodied as an animated train having one or more portions that can be animated. As shown, the animated object is adapted for use as a writing instrument sharpener 10. Once the writing instrument 5 is inserted into an aperture 32 in the main cabin of the train car 70, the coupling or hinged side rods and the wheels on the train car 70 may start to turn and a smoke may billow out of the stack in the train car 70. Likewise, an audible sound such as choo-choo or the like may be provided by the train car 70. As with the unicorn 60 described above, the electric motor 52 may activate a solenoid or the like to cause pivoted motion of the hinged side rods and rotational movement of the wheels 26 of the train 70.

Pushing the vehicle 12 along a friction surface may cause the generation of power, which in turn may be used to power the illumination source 40. The illumination source 40 may be an LED, an incandescent, halogen, fluorescent or any other type of suitable illumination source according to this subject matter.

As shown in FIGS. 8-13, the vehicle 12 housing can be constructed into a variety of shapes and sizes of vehicles. It is to be understood that the writing instrument sharpener 10 may take a variety of different shapes from which various sharpeners may be created. As such, a variety of different preferences may be provided for a vast broad-section of consumers.

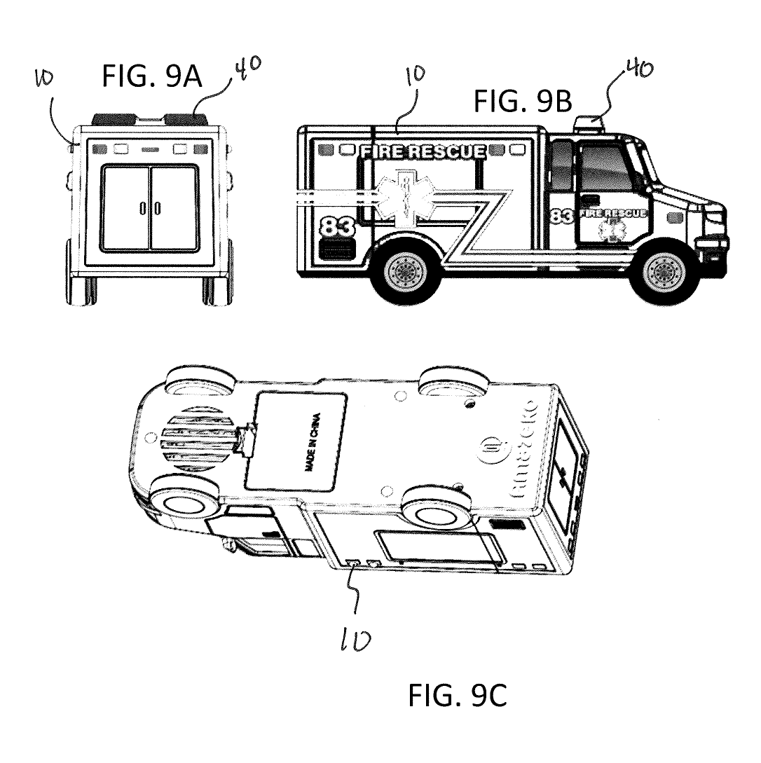

FIGS. 8A-8D illustrate a front, a top, a side and a lower view of the animated writing instrument sharpening device as a fire rescue vehicle. FIGS. 9A-9C is a rear, another side and a lower perspective view of the animated writing instrument sharpening device as a fire rescue vehicle. Various designs for the fire rescue truck and/or other vehicle shape or design are possible to suit a consumer's interest.

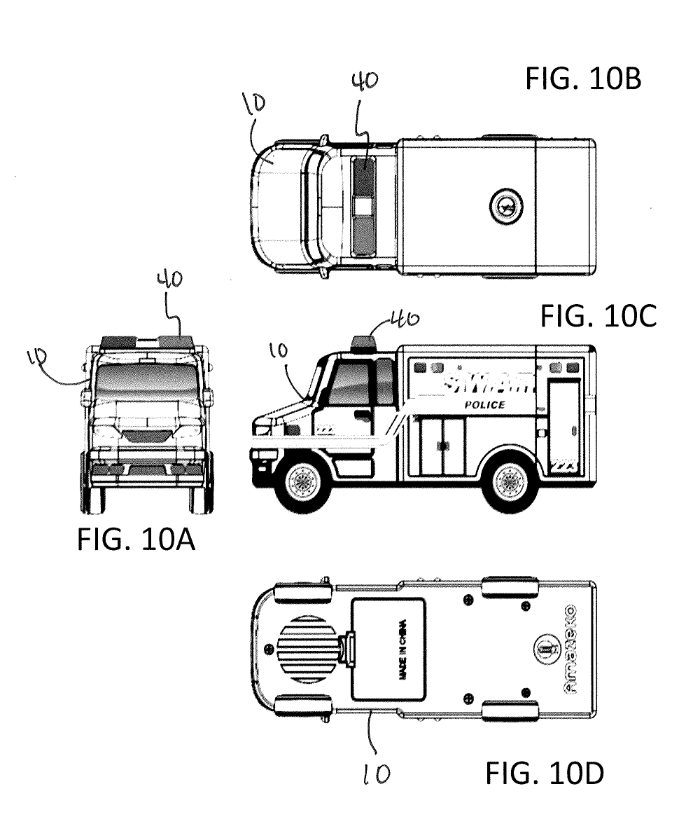

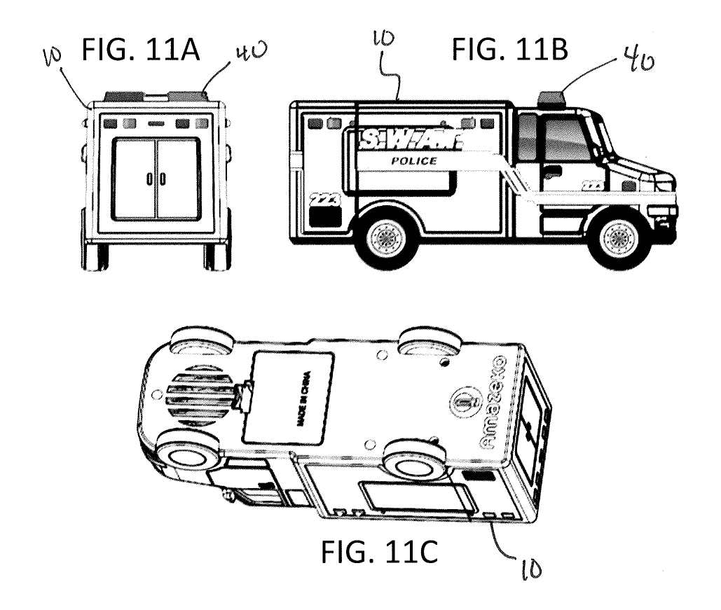

FIGS. 10A-10D illustrate a front, a top, a side and a lower view of the animated writing instrument sharpening device as a police vehicle. FIGS. 11A-11C is a rear, another side and a lower perspective view of the animated writing instrument sharpening device as a police vehicle. The police vehicle can take a variety of different designs suitable to a consumer's interest.

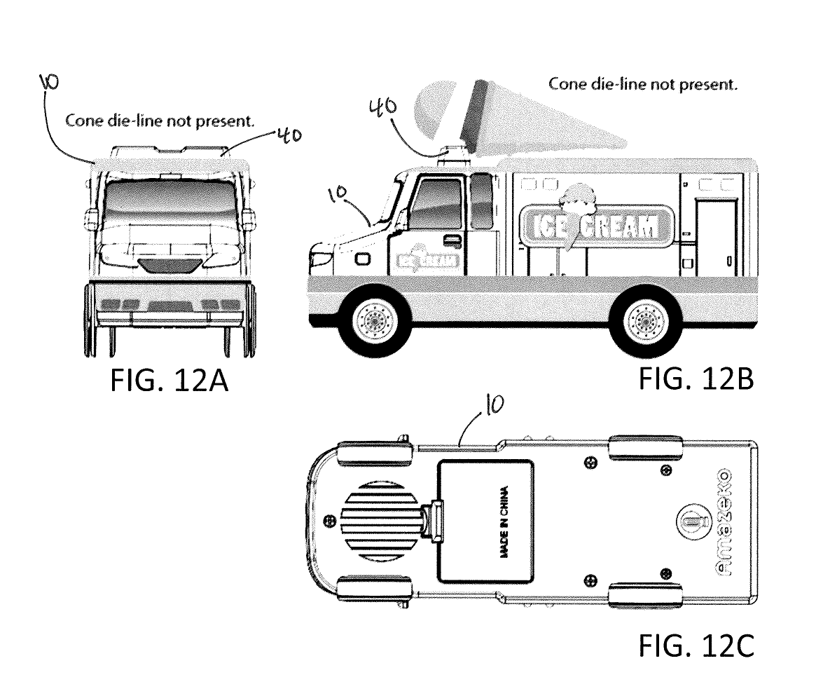

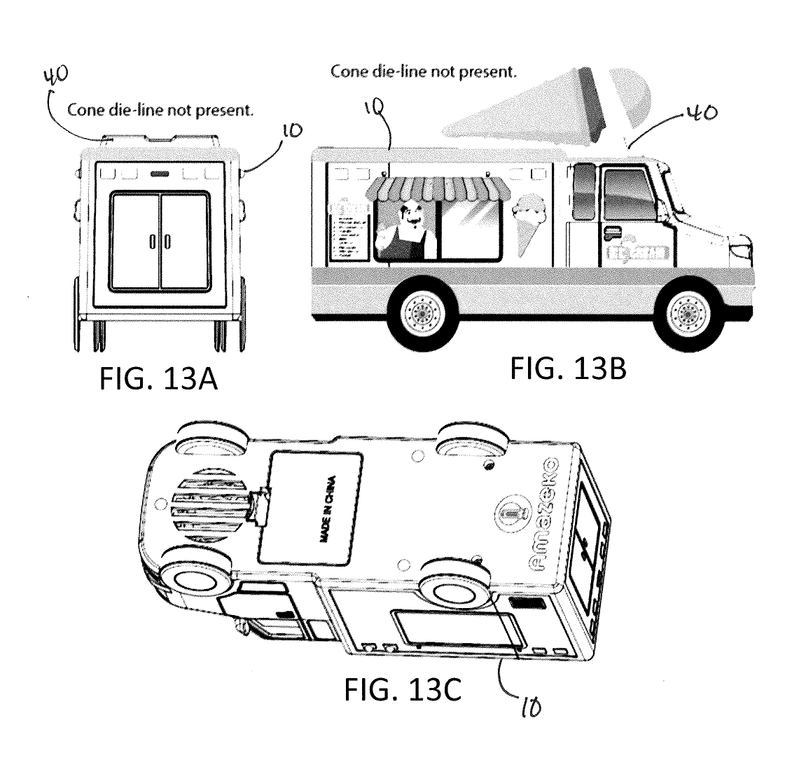

FIGS. 12A-12C illustrate a front, a top, a side and a lower view of the animated writing instrument sharpening device as an ice cream vehicle. FIGS. 13A-13C is a rear, another side and a lower perspective view of the animated writing instrument sharpening device as an ice cream vehicle. Various designs for the ice cream vehicle are possible to suit a consumer's interest.

The animated sharpening device 10 can be formed from a variety of different processes, such as die casting, machining, forging, stamping, rolling, extruding, sintering or any other suitable process for forming the sharpening device 10. It is to be understood that the sharpening device 10 is not to be limited to the specific form or arrangement of parts herein described and shown except insofar as such limitations are included in the claim.

The illustrations and examples provided herein are for explanatory purposes and are not intended to limit the scope of the appended claims. It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

What is claimed:

1. An animated writing instrument sharpener comprising:
a housing;
a sharpener disposed in the housing for sharpening a writing instrument; and
an electronic circuit connecting an illumination source to the sharpener, wherein when the writing instrument is received within the sharpener, the electronic circuit sends an activation signal to activate the illumination source and cause an animation to occur.

2. The animated writing instrument sharpener recited in claim 1, wherein the writing instrument sharpener is a pencil sharpener.

3. The animated writing instrument sharpener recited in claim 1, wherein the electronic circuit sends an activation signal to activate an audio source.

4. The animated writing instrument sharpener recited in claim 1, wherein the housing has an aperture adapted to receive the writing instrument.

5. The animated writing instrument sharpener recited in claim 4, wherein the aperture is a tactile touch switch adapted to turn off power as a safety precaution when a body portion of user contacts a surface surrounding the aperture in the housing.

6. The animated writing instrument sharpener recited in claim 1, wherein the housing is a vehicle housing.

7. The animated writing instrument sharpener recited in claim 1, wherein the housing is an animal figurine.

8. The animated writing instrument sharpener recited in claim 1, wherein the electronic circuit includes an auto-stop switch to stop sharpening at a predetermined time.

9. A writing instrument sharpener comprising:
a housing;
a sharpener disposed in the housing for sharpening a writing instrument; and
an electronic circuit, wherein when the writing instrument is received within the sharpener, the electronic circuit sends an activation signal to a portion of the instrument sharpener that causes animation to occur.

10. The writing instrument sharpener recited in claim 9, wherein when the writing instrument is received within an aperture, a portion of the writing instrument sharpener is powered by a motor to animate.

11. The writing instrument sharpener recited in claim 10, wherein the aperture is a tactile touch mechanism connected to a switch adapted to turn off power to the motor as a safety precaution when a body portion of user contacts a surface surrounding the aperture in the housing.

12. The writing instrument sharpener recited in claim 9, wherein when the electronic circuit sends another activation signal to initiate an audio source.

13. The writing instrument sharpener recited in claim 9, wherein the electronic circuit includes an auto-stop switch to stop sharpening at a predetermined time.

14. A writing instrument sharpener comprising:
a housing having an aperture;
a sharpener disposed in the housing for sharpening a writing instrument positioned through the aperture; and
an electronic circuit, wherein when the writing instrument is received within the aperture of the instrument sharpener, the electronic circuit sends an activation signal to the instrument sharpener that causes an illumination source and an audio source to emanate from the instrument sharpener.

15. The writing instrument sharpener recited in claim 14, wherein when the writing instrument is inserted into the aperture, a portion of the writing instrument sharpener is powered by a motor to animate.

16. The writing instrument sharpener recited in claim 14, wherein the aperture is a tactile touch switch adapted to turn off power as a safety precaution when a body portion of user contacts a surface surrounding the aperture in the housing.

17. The writing instrument sharpener recited in claim 14, wherein the electronic circuit includes an auto-stop switch to stop sharpening at a predetermined time.
